(19) United States
(12) Patent Application Publication
(10) Pub. No.: US 2007/0025564 A1
(43) Pub. Date: Feb. 1, 2007

(54) Sound source separation apparatus and sound source separation method

(75) Inventors: Takashi Hiekata, Kobe-shi (JP); Hiroshi Hashimoto, Kobe-shi (JP)

Correspondence Address: REED SMITH LLP, 3110 FAIRVIEW PARK DRIVE, SUITE 1400, FALLS CHURCH, VA, 22042, US

(73) Assignee: Kabushiki Kaisha Kobe Seiko Sho

(21) Appl. No.: 11/490,147

(22) Filed: Jul. 21, 2006

(30) Foreign Application Priority Data
Jul. 29, 2005 (JP) 2005220972

(51) Int. Cl. H04B 15/00

(52) U.S. Cl. 381/94.2

(57) ABSTRACT

A sound source separation apparatus performs a discrete Fourier transform on each of a plurality of mixed sound signals for a predetermined time length in a time domain and sequentially transforms the mixed sound signals to mixed sound signals in a frequency domain. The apparatus allocates learning calculations of a separating matrix using a blind source separation based on independent component analysis to a plurality of DSPs for each of separate mixed sound signals generated by separating the frequency-domain-based mixed sound signal into a plurality of pieces with respect to frequency range and causes the DSPs to perform the learning calculations in parallel so as to sequentially output the separating matrix. The apparatus generates a separated signal corresponding to the sound source signal from the frequency-domain-based mixed sound signal by performing a matrix calculation using the separating matrix and performs an inverse discrete Fourier transform on the separated signal.

### BACKGROUND OF THE INVENTION

1. Field of the Invention

The present invention relates to a sound source separation apparatus and a sound source separation method.

2. Description of the Related Art

In a space that accommodates a plurality of sound sources and a plurality of microphones, each microphone receives a sound signal in which individual sound signals from the sound sources (hereinafter referred to as “sound source signals”) overlap each other. Hereinafter, the received sound signal is referred to as a “mixed sound signal”. A method of identifying (separating) individual sound source signals on the basis of only the plurality of mixed sound signals is known as a “blind source separation method” (hereinafter simply referred to as a “BSS method”).

In addition, among a plurality of sound source separation processes based on the BSS method, a sound source separation process of a BSS method based on the independent component analysis method (hereinafter simply referred to as “ICA”) has been proposed. In the BSS method based on ICA (hereinafter referred to as “ICA-BSS”), a predetermined separating matrix (an inverse mixture matrix) is optimized using the fact that the sound source signals are independent from each other. The plurality of sound source signals input from a plurality of microphones are subjected to a filtering operation using the optimized separating matrix so that the sound source signals are identified (separated). At that time, the separating matrix is optimized by calculating a separating matrix that is subsequently used in a sequential calculation (learning calculation) on the basis of the signal (separated signal) identified (separated) by the filtering operation using a separating matrix set at a given time.

The sound source separation process of the ICA-BSS can provide a high sound source separation performance (the performance of identifying the sound source signals) if the sequential calculation (learning calculations) for obtaining a separating matrix is sufficiently carried out. However, to obtain the sufficient sound source separation performance, the number of sequential calculations (learning calculations) for obtaining the separating matrix used for the separation process must be increased. This results in an increased computing load. If this calculation is carried out using a widely used processor, the computing time that is several times the time period of the input mixed sound signal is required. As a result, although the sound source separation process can be carried out in real time, the duration of the update cycle (learning cycle) of the separating matrix used for the sound source separation process is increased, and therefore, the sound source separation process cannot rapidly follow changes in an audio environment. This can be said for the sound source separation process for a mixed sound signal of 2 channels and 8 kHz. If the number of channels (the number of microphones) increases (e.g., from 2 to 3) or the sampling rate of the mixed sound signal increases (e.g., from 8 kHz to 16 kHz), this sound source separation process becomes much less practical due to the increase in an amount of processing for the learning calculation.

### SUMMARY OF THE INVENTION

Accordingly, it is an object of the present invention to provide a sound source separation apparatus and a sound source separation method having a quick response to changes in an audio environment while maintaining the high sound source separation performance even when a widely used processor (computer) is applied.

The sound source separation apparatus and a sound source separation method provide the following basic processing and advantages.

According to the present invention, a sound source separation apparatus includes a plurality of sound input means (e.g., microphones) for receiving a plurality of mixed sound signals, sound source signals from a plurality of sound sources being overlapped in each of the mixed sound signals, frequency-domain transforming means for performing a discrete Fourier transform on each of the mixed sound signals for a predetermined time length in a time domain and sequentially transforming the mixed sound signals to mixed sound signals in a frequency domain (hereinafter referred to as “frequency-domain-based mixed sound signals”), separating matrix calculating means for allocating learning calculations of a separating matrix using a blind source separation based on an independent component analysis to a plurality of processors for each of separate frequency-domain mixed sound signals generated by separating the frequency-domain-based mixed sound signal into a plurality of pieces with respect to frequency range and causing the plurality of processors to carry out the learning calculations in parallel so as to sequentially output the separating matrix, sound source separating means for sequentially generating a separated signal corresponding to the sound source signal from the frequency-domain-based mixed sound signal by performing a matrix calculation using the separating matrix, and time domain transforming means for performing an inverse discrete Fourier transform on one or more separated signals (i.e., transforming back to the time domain). Additionally, a sound source separation apparatus method causes a computer to such processes.

Thus, even when the plurality of processors (computers) are widely used ones, the learning calculation of a separating process can be completed in a relatively short cycle by using parallel processing of the processors. Consequently, a sound source separation having a quick response to changes in an audio environment can be provided while maintaining the high sound source separation performance.

Additionally, the allocation of the separate frequency-domain mixed sound signals to the plurality of processors (computers) may be determined on the basis of a processing load of each processor (computer).

Thus, when each processor is used for the sound source separation process and other processes and the load of a particular processor temporarily becomes high due to processing of the other processes, the learning calculation performed by the particular processor does not become a bottleneck. Thus, the delay of the completion of the total learning calculation of the separating matrix can be prevented.

For example, the allocation of the separate frequency-domain mixed sound signals to the processors may be determined by selecting a candidate allocation from among a plurality of predetermined candidate allocations on the basis of a processing load of each processor.

Thus, when the patterns of load variations in the processors can be estimated in advance, the load balancing can be simply and appropriately determined.

Furthermore, the allocation of the separate frequency-domain mixed sound signals to the processors may be determined by means of a computation based on actual times spent for the learning calculations of the separating matrix by the plurality of processors so that the learning calculations of the separating matrix by the processors are completed at the same time or at almost the same time.

Thus, the load balancing of the processors can be optimized. Additionally, even when the variation in the load balancing of the processors cannot be estimated in advance, the present invention is applicable.

### BRIEF DESCRIPTION OF THE DRAWINGS

FIG. 1 is a block-diagram of a the sound source separation apparatus X according to an embodiment of the present invention;

FIG. 2 is a flow chart of the sound source separation process performed by the sound source separation apparatus X;

FIG. 3 is a time diagram illustrating a first example of the calculation of a separating matrix performed by the sound source separation apparatus X;

FIG. 4 is a time diagram illustrating a second example of the calculation of a separating matrix performed by the sound source separation apparatus X;

FIG. 5 is a block diagram of a sound source separation apparatus Z1, which carries out a sound source separation process using a BSS method based on a “TDICA” method; and

FIG. 6 is a block diagram of a source separation apparatus Z2, which carries out a sound source separation process based on a “FDICA” method.

### DESCRIPTION OF THE PREFERRED EMBODIMENTS

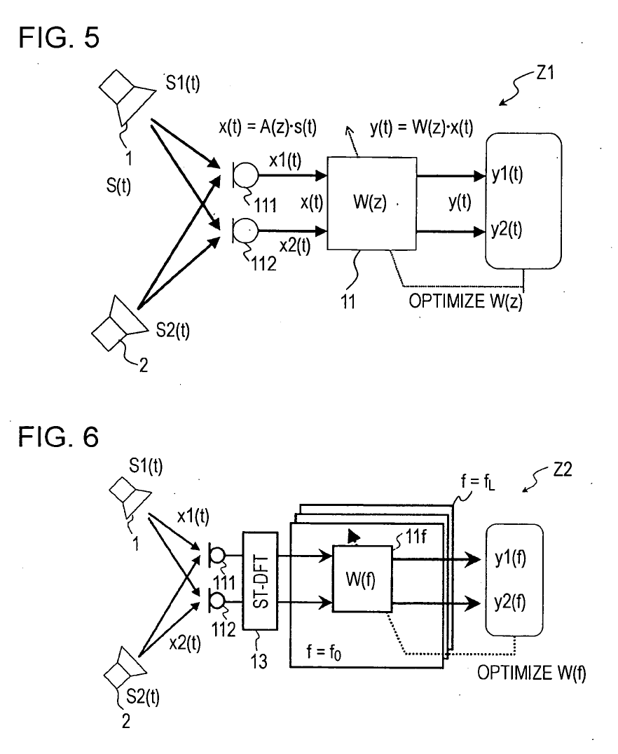

Before embodiments of the present invention are described, an exemplary sound source separation apparatus using a blind source separation based on a variety of the ICAs, which is applicable as an element of the present invention, is described with reference to block diagrams shown in FIGS. 5 and 6.

A sound source separation process and an apparatus executing the process, which are described below, are applied in an environment in which a plurality of sound sources and a plurality of microphones (sound input means) are placed in a predetermined acoustic space. In addition, the sound source separation process and the apparatus executing the process relate to those that generate one or more separated signals separated (identified) from a plurality of mixed sound signals including overlapped individual sound signals (sound source signals) input from the microphones.

FIG. 5 is a block diagram schematically illustrating an existing sound source separation apparatus Z1, which carries out a sound source separation process using a BSS method based on a time-domain independent component analysis (hereinafter referred to as a “TDICA” method). The TDICA method is one type of ICA technique.

The sound source separation apparatus Z1 receives sound source signals S1(t) and S2(t) (sound signals from corresponding sound sources) from two sound sources 1 and 2, respectively, via two microphones (sound input means) 111 and 112. A separation filtering processing unit 11 carries out a filtering operation on 2-channel mixed sound signals x1(t) and x2(t) (the number of channels corresponds to the number of the microphones) using a separating matrix W(z). In FIG. 5, an example of the two channels is shown. However, the same process can be applied to the case in which there are more than two channels. Let n denote the number of input channels of a mixed sound signal (i.e., the number of microphones), and let m denote the number of sound sources. In the case of sound source separation using the ICA-BSS, it should be satisfied that n≧m.

In each of the mixed sound signals x1(t) and x2(t) respectively collected by the microphones 111 and 112, the sound source signals from the sound sources are overlapped. Hereinafter, the mixed sound signals x1(t) and x2(t) are collectively referred to as “x(t)”. The mixed sound signal x(t) is represented as a temporal and spatial convolutional signal of a sound source signal S(t). The mixed sound signal x(t) is expressed as follows:
x(t)=A(z)·S(t) (1)
where A(z) represents a spatial matrix used when signals from the sound sources are input to the microphones.

The theory of sound source separation based on the TDICA method employs the fact that the sound sources in the sound source signal S(t) are statistically independent. That is, if x(t) is obtained, S(t) can be estimated. Therefore, the sound sources can be separated.

Here, let W(z) denote the separating matrix used for the sound source separation process. Then, a separated signal (i.e., identified signal) y(t) is expressed as follows:
y(t)=W(z)·x(t) (2)

Here, W(z) can be obtained by performing a sequential calculation (learning calculation) on the output y(t). The separated signals can be obtained for the number of channels.

It is noted that, to perform a sound source combining process, a matrix corresponding to the inverse calculation is generated from information about W(z), and the inverse calculation is carried out using this matrix. Additionally, to perform the sequential calculation, a predetermined value is used as an initial value of the separating matrix (an initial matrix).

By performing a sound source separation using such an ICA-BSS, from, for example, mixed sound signals for a plurality of channels including human singing voice and a sound of an instrument (such as a guitar), the sound source signals of the singing voice is separated (identified) from the sound source signals of the instrument.

Here, equation (2) is rewritten as:

$$y ( t ) = {\sum }_{n = 0}^{D - 1} w ( n ) x ( t - n ) \qquad ( 3 )$$

where D denotes the number of taps of the separating filter W(n).

The separation filter (separating matrix) W(n) in equation (3) is sequentially calculated by means of the following equation (4):

$$\begin{matrix}{w}^{[ j + 1 ]} ( n ) = {w}^{[ j ]} ( n ) - α {\sum }_{d = 0}^{D - 1} \{ off - diag \\ {〈 φ ( {y}^{[ j ]} ( t ) ) {{y}^{[ j ]} ( t - n + d )}^{T} 〉}_{t} \} \cdot {w}^{[ j ]} ( d )\end{matrix} \qquad ( 4 )$$

where α denotes the update coefficient, [j] denotes the number of updates, <. . . >ₜ denotes a time-averaging operator, “off-diag X” denotes the operation to replace all the diagonal elements in the matrix X with zeros, and φ( . . . ) denotes an appropriate nonlinear vector function having an element such as a sigmoidal function.

That is, by sequentially applying the output y(t) of the previous (j) to equation (4), W(n) for the current (j+1) is obtained.

A known sound source separation apparatus Z2, which carries out a sound source separation process using a FDICA (Frequency-Domain ICA) method, is described next with reference to a block diagram shown in FIG. 6. The FDICA method is one type of ICA technique.

In the FDICA method, the input mixed sound signal x(t) is subjected to a short time discrete Fourier transform (hereinafter referred to as a “ST-DFT” process) on a frame-by-frame basis. The frame is a set of signals separated from the input mixed sound signal x(t) by predetermined periods using a ST-DFT processing unit 13. Thereafter, the observed signal is analyzed in a short time. After the SF-DFT process is carried out, a signal of each channel (a signal of a frequency component) is subjected to a separation filtering process based on the separating matrix W(f) by a separation filtering processing unit 11f. Thus, the sound sources are separated (i.e., the sound source signals are identified). Here, let f denote the frequency range and m denote the analysis frame number. Then, a separated signal (identified signal) y(f, m) is expressed as follows:
y(f, m)=W(f)·x(f, m) (5)

Here, the update equation of the separation filter W(f) can be expressed, for example, as follows:
W_{(ICA)}^{[i+1]}(f)=W_{(ICA)}^{[i]}(f)−η(f)[off-diag{<φ(Y_{(ICA)}^{[i]}(f,m))Y_{(ICA)}^{[i]}(f,m)^{H}>ₘ}]W_{(ICA)}^{[i]}(f) (6)
where η(f) denotes the update coefficient, i denotes the number of updates, <. . . > denotes a time-averaging operator, H denotes the Hermitian transpose, “off-diag X” denotes the operation to replace all the diagonal elements in the matrix X with zeros, and φ( . . . ) denotes an appropriate nonlinear vector function having an element such as a sigmoidal function.

According to the FDICA method, the sound source separation process is regarded as instantaneous mixing problems in narrow bands. Thus, the separating filter (separating matrix) W(f) can be relatively easily and reliably updated.

Here, in the learning calculation of the separating matrix W(f) according to-the FDICA technique, the learning can be independently carried out for each frequency band (i.e., the calculation results do not interfere with each other). Accordingly, by separating the entire frequency range into, a plurality of sub-frequency ranges, the learning calculations for the sub-frequency ranges can be concurrently carried out (parallel processing).

This FDICA technique (FDICA method) is applied to a learning calculation process of the separating matrix W(f) according to the blind source separation method based on independent component analysis. The FDICA method is also applied to the process in which a matrix calculation is carried out using the separating matrix W(f) so as to sequentially generate separated signals corresponding to the sound source signals from a plurality of the mixed sound signals.

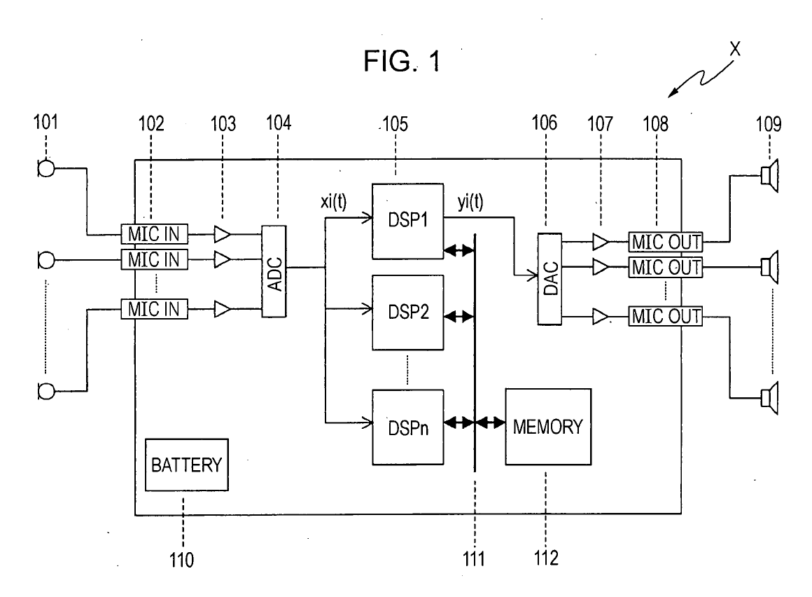

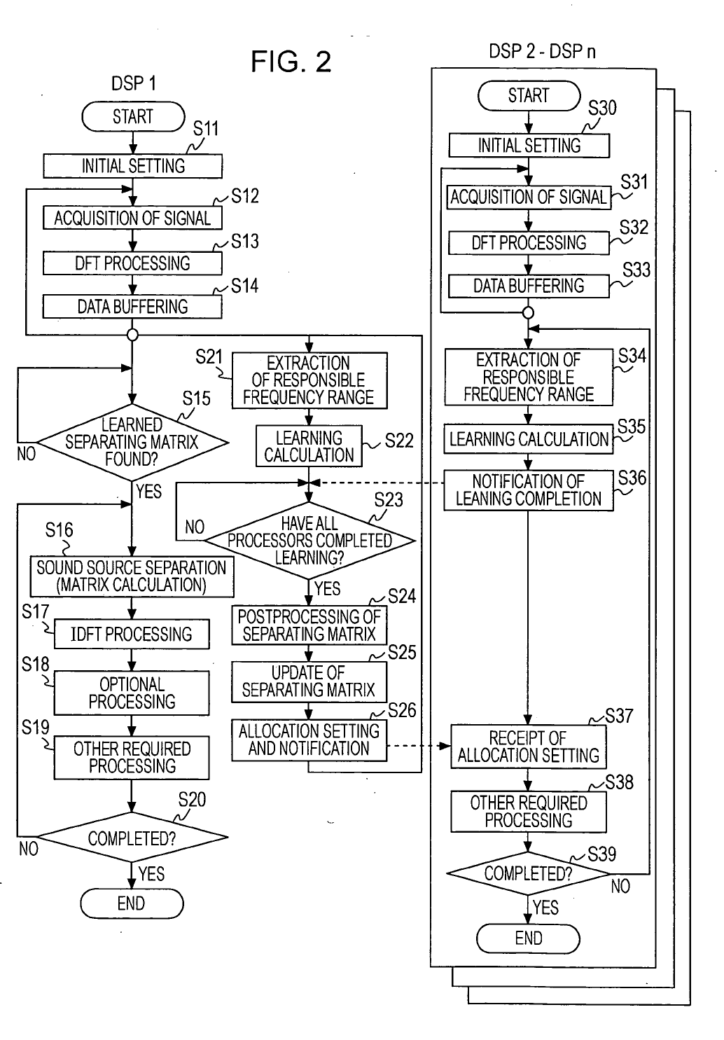

### First Embodiment (FIGS. 1 and 2)

A sound source separation apparatus X according to first to third embodiments of the present invention is described below with reference to a block diagram shown in FIG. 1.

The sound source separation apparatus X is used in an acoustic space in which a plurality of sound sources (less than or equal to n) are placed. The sound source separation apparatus X receives a plurality of mixed sound signals via a plurality of microphones (sound input means) 101 and sequentially generates separated signals corresponding to sound signals of the sound sources from the mixed sound signals.

As shown in FIG. 1, the sound source separation apparatus X includes the plurality of microphones 101 (n microphones 101) placed in the acoustic space, a plurality of microphone input terminals 102 (n microphone input terminals 102), which are respectively connected to the microphones 101, an amplifier 103 for amplifying mixed sound signals input from the microphone input terminals 102, an analog-to-digital (A/D) converter 104 for converting the mixed sound signals to digital signals, a plurality of digital signal processors (DSPs) 105 (n DSPs 105), and a digital-to-analog (D/A) converter 106. The DSP is one type of processor. The n DSPs process the n digitized mixed sound signals, respectively. Hereinafter, the DSPs are referred to as a DSP 1, DSP 2, . . . , and DSP n. The D/A converter 106 converts a plurality of separated signals (n separated signals) sequentially output from one of the DSPs (DSP 1) to analog signals. The sound source separation apparatus X further includes an amplifier 107 for amplifying the plurality of analog separated signals (n analog separated signals), speaker output terminals 108 corresponding to a plurality of external speakers 109 (n speakers 109) and respectively connected to signal lines of the amplified separated signals, a memory 112 (e.g., a nonvolatile flash memory from which or into which a variety of data are read or written), a bus 111 serving as data transmission paths between the DSPs 105 and between each of the DSPs 105 and the memory 112, and a battery 110 for supplying electric power to each component of the information recording/playback apparatus 100.

According to the first embodiment, all the DSPs 1 to n concurrently carry out the learning computations of the separating matrix W(f) using the above-described FDICA method. Of the DSPs, the DSP 1 sequentially carries out a matrix calculation using the separating matrix W(f) learned by means of all the DSPs 1 to n so as to carry out a sound source separation process for the mixed sound signals. Thus, from the plurality of mixed sound signals input via the plurality of microphones (sound input means) 101, separated signals corresponding to the sound source signals are sequentially generated and are output to the speakers 109.

By performing this process, each of a plurality of separated signals corresponding to sound source signals, which is less than or equal to n, is individually output from one of the n speakers 109. Such a sound source separation apparatus X can be applied to, for example, a hands-free telephone and a sound collecting apparatus of a television conference system.

A micro processing unit (MPU) incorporated in each of the DSPs 1 to n executes a sound processing program prestored in an internal ROM so as to carry out processes including a process concerning sound source separation (separated signal output processing: a learning calculation and a matrix calculation using the separating matrix).

Additionally, the present invention can be considered to be a sound source separation method for a process executed by a processor (computer), such as the DSP 105.

The procedure of the sound source separation process executed by each of the DSPs 1 to n is described next with reference to a flow chart shown in FIG. 2. In the first embodiment, the DSP 2 to n (hereinafter referred to as the “DSPs 2-n”) execute a similar sound source separation process, and therefore, the following two processes: the process of the DSP 1 and the process of the DSPs 2-n are described. The following processes start when a predetermined start operation is carried out using an operation unit (not shown) of the sound source separation apparatus X, such as an operation button, and the processes end when a predetermined end operation is carried out. The following reference symbols S11, S12, . . . denote the identification symbols of steps of the procedure.

When the predetermined start operation is detected, the DSP 1 and DSPs 2-n carry out a variety of initialization processes (S11 and S30).

For example, the initialization processes include the initial value setting of the separating matrix W(f) and the load balance setting of the learning calculation of the separating matrix W(f) among the DSP 1 and DSPs 2-n, which will be described below.

Subsequently, each of the DSP 1 and DSPs 2-n receives the mixed sound signal x(t) for the input period of time from the A/D converter 104 (S12 and S31). A short-time discrete Fourier transform (ST-DFT) process is carried out for every frame signal of the mixed sound signal x(t) for a predetermined time length (e.g., 3 seconds) so that the frame signal is converted to a signal in a frequency domain (S13 and S32). Furthermore, the frame signal converted to the frequency domain is buffered in the internal main memory (RAM) (S14 and S33). Thus, a plurality of the frame signals in the time domain are converted to a plurality of frame signals in the frequency domain (an example of a frequency-domain-based mixed sound signal) and are stored in the main memory. This is an example of a frequency domain conversion process.

Thereafter, every time one frame signal is input (at a frequency of the time length of the frame signal), the ST-DFT process is sequentially carried out on the frame signal to convert the frame signal to a frequency-domain-based mixed sound signal. The converted frame signals are buffered (S12 to S14 and S31 to S33). This operation is periodically carried out until the stop operation is carried out.

In this embodiment, each of the DSPs carries out the ST-DFT process. However, one of the DSPs may carry out the ST-DFT process and may transmit the result to the other DSPs.

Subsequently, the process performed by the DSP 1 is divided into the following three processes: the above-described process at steps S12 to S14, a process relating to a learning calculation of the separating matrix W(f) (S21 to S26), and a process to generate a separated signal by carrying out a matrix calculation (filtering operation) using the separating matrix W(f) (a sound source separation process: S15 to S20). These three processes are carried out in parallel.

On the other hand, the DSPs 2-n carry out the following two processes in parallel: the above-described process at step S31 to S33 and a process relating to the learning calculation of the separating matrix W(f) performed in cooperation with the DSP 1 (S34 to S39).

Here, the allocation of a plurality of signals, which are generated by dividing the frame signal in the frequency domain (frequency-domain-based mixed sound signal) by the frequency ranges, to the DSPs 1 to n is predetermined. Hereinafter, this signal is referred to as a “separate frame signal” (an example of the frequency domain separate mixed sound signal). That is, allocation of the frequency ranges of the learning calculation to the DSPs 1 to n is predetermined. The initial values of the responsibility are set at the initialization time described at steps S11 and S31. Thereafter, the value is updated as needed by an allocation setting process (S26), which will be described below.

The learning calculation process of each DSP is described below.

First, each of the DSPs 1 to n extracts a separate frame signal of the frequency range for which the DSP is predetermined to be responsible from the frame signal (mixed sound signal) that has been converted to the frequency domain and buffered (S21 and S34).

Subsequently, each of the DSPs 1 to n carries out a learning calculation of the separating matrix W(f) on the basis of the FDICA method using the extracted separate frame signal (i.e., the signal generated by dividing the frame signal in the frequency domain (mixed sound signal for a predetermined time length) by the frequency ranges. This process is carried out by the DSPs 1 to n in parallel (S22 and S35). In addition, the DSPs 2-n send the learning end notifications to the DSP 1 when the DSPs 2-n complete the learning calculations they are responsible for (S36). Upon receiving the notification, the DSP 1 monitors whether all the calculations including the calculation of the DSP 1 are completed (S23). This series of separating matrix calculating operations is sequentially repeated for each frame signal.

It is noted that the separating matrix referenced and sequentially updated during the learning calculation is a work matrix defined as a work variable. This work matrix is different from the separating matrix used for the sound source separation process at step S16, which will be described below.

Here, when sending the learning end notification, each of the DSPs 2-n that has carried out the learning calculation detects an index representing the status of the computing load of this calculation and sends the index to the DSP 1. Similarly, the DSP 1 detects an index thereof. The details of this process are described below.

When the DSP 1 determines that all the DSPs have completed their learning calculations, the DSP 1 carries out post processing in which the coefficient crossing of the separating matrix W(f) for each frequency range that one of the DSPs is responsible for is modified (this process is widely known as the solution of a permutation problem) and the gain is adjusted (S24). Thereafter, the separating matrix W(f) used for the sound source separation is updated to the separating matrix W(f) used after the post processing (S25). That is, the content of the work matrix provided for the learning is reflected in the content of the separating matrix W(f) provided for the sound source separation.

Thus, the subsequent sound source separation process (i.e., a process at step S16, which is described below) is carried out by a matrix calculation (a filter process) using the updated separating matrix W(f).

Furthermore, the DSP 1 determines the allocation of the subsequent separate frame signals (frequency-domain based separate mixed sound signal) for the next learning calculation of each of the DSPs 1 to n on the basis of the status of the computing load during the learning calculation at this time (i.e., the index representing the status of the computing load detected and sent at step S36). The DSP 1 then sends information on the determined allocation to the DSPs 2-n (S26: an example of a signal allocation setting process). The DSPs 2-n receive the allocation information (S37).

The allocation information on the separate frame signals is, for example, information indicating that, when the entire frequency range of a frame signal (mixed sound signal) to be processed is predetermined and the frequency range is evenly divided into frequency ranges (separate frequency ranges) 0 to M, the DSP 1 is responsible for the frequency ranges 0 to m1, the DSP 2 is responsible for the frequency ranges m1+1 to m2, the DSP 3 is responsible for the frequency ranges m2+1 to m3, . . . , and the DSP n is responsible for the frequency ranges mn to M. Here, m denotes a natural number (0<m<M).

Thus, it is determined from which frequency range of the subsequent frame signal each of the DSPs 1 to n extracts a signal when the DSP processes the subsequent frame signal at steps S21 and S34.

The examples of the allocation information and the allocation of the separate frame signals based on the allocation information will be described below.

As described above, in the DSP 1, the process relating to the learning calculation of the separating matrix W(f) (S21 to S26) is repeated until an end operation is carried out.

On the other hand, after receiving the allocation information (S37) and performing the other process (S38) in accordance with the status, each of the DSPs n-2 repeats the process from step S34 to step S39 until the DSP n-2 detects the end operation (S39). Thus, the separating matrix W(f) used for the sound source separation, which will be described below, is periodically updated.

Here, the DSP 1 carries out the processes from monitoring the end of the learning calculation to updating the separating matrix W(f) (from step S23 to step S25) and the allocation setting process and sending process (S26). However, one or more of the DSPs 2 to n may carry out these processes.

The DSP 1 carries out a process to generate a separated signal (S15 to S20) while the DSPs 1 to n are carrying out the above-described learning calculation process of the separating matrix W(f).

That is, the DSP 1 monitors whether the separating matrix W(f) has been updated from at least the initial matrix (S15). If the separating matrix W(f) has been updated, the DSP 1 sequentially carries out a matrix calculation (a filtering process) on the plurality of buffered frame signals (n frame signals) from the first frame signal using the separating matrix W(f) (S16). Thus, separated signals corresponding to respective sound source signals are generated from the plurality of frame signals.

Furthermore, the DSP 1 carries out an inverse discrete Fourier transform (an IDFT process) on each of the separated signals generated at step S16 (S17: a time-domain transform process). Thus, the separated signals are transformed from frequency-domain signals to time-domain signals (time-series signals).

Still furthermore, in response to an instruction specifying a noise removing process (spectrum subtraction), an equalizing process, or an optional sound process (such as an MP3 compression process) input from an operation unit (not shown), the DSP 1 carries out the specified process (optional process) on the separated signals converted to a time domain. The DSP 1 then outputs the separated signals subjected to the optional process to the D/A converter 106 connected downstream thereof (S18). If the optional process is not specified, the DSP 1 directly outputs the separated signals converted to a time domain at step S17 to the D/A converter 106.

The DSP 1 then carries out an additional process (such as a process for receiving an additional input operation from the operation unit) (S19). Subsequently, the DSP 1 determines whether an end operation has been carried out (S20). The process from step S11 to step S14, the process from step S16 to step S20, and the process from step S21 to step S26 are sequentially repeated.

Thus, separated signals corresponding to respective sound sources are generated (separated) from an input mixed sound signal. The separated signals are sequentially output from the speakers 109 in real time. At the same time, the separating matrix W(f) used for the sound source separation is periodically updated by the learning calculation.

According to such a configuration and process, even when a plurality of processors (the DSP 1 to n) are practical or widely used ones, the parallel processing of the processors enables the learning calculation of the separating matrix W(f) in a relatively short cycle. Accordingly, sound source separation having a quick response to changes in an audio environment can be provided while maintaining the high sound source separation performance.

According to this embodiment of the present invention, a plurality of processors carry out the learning calculation in parallel. In such a case, the entire learning time depends on the learning time of the slowest processor (DSP) (the learning time of a processor having the highest computing load when all the processors are similar). Here, if the variation in the computing loads of the DSPs is small, allocation of the frequency ranges (separate frame signals) to the DSPs can be predetermined such that the times required for the learning calculations of the DSPs are equal to each other. Consequently, the entire learning time becomes minimal and the separating matrix W(f) can be trained and updated in a short cycle. Therefore, sound source separation having a quick response to changes in an audio environment can be provided.

However, if the variation in the computing loads of the DSPs is large (such as a case where the processing load of the DSP 1 largely varies whether or not the DSP 1 executes the optional process (S18)), the processing load of some processor temporarily increases even when the total processing power of the processors is sufficient. If the processor requires a more learning calculation time than the other processors, the total learning time increases.

Accordingly, as described above, according to the sound source separation apparatus X, the DSP 1 sets the allocation of the separate frame signals (frequency-domain based separate mixed sound signals) to the plurality of DSPs on the basis of the index representing the status of the processing load of each DSP.

An exemplary allocation of the separate frame signals at step S26 is described below.

### Second Embodiment (FIG. 2)

First, an example of allocation of separate frame signals according to a second embodiment is described.

In the second embodiment, when the DSPs 1 to n carry out the learning calculation of the separating matrix W(f), the actual time spent for the learning calculation is detected as the index of the status of the computing load. On the basis of the detection result, the allocation of the separate frame signals (allocation of the frequency ranges) to the DSPs is determined by calculation so that the learning calculations of the separating matrix W(f) by the DSPs are completed at the same time or at almost the same time.

Here, let tm(i) denote the time (actual time) spent for the i-th learning calculation of the separating matrix W(f) by the DSP m (m=1, . . . n), km(i) denote the number of responsible frequency ranges (separate frequency ranges) at that time, and N denote the number of divisions of the entire frequency range (i.e., the number of frequency ranges). Here, it is assumed that the computing load of each DSP for a process other than the learning calculation is almost the same at an ith learning time and at (i+1)th learning time. To complete the (i+1)th learning calculation of the DSPs at the same time (i.e., to make the learning calculation times the same), the following simultaneous equations, for example, can be applied:
kp(i+1)·tp(i)/kp(i)=kj(i+1)·tj(i)/kj(i) (7)
i k1(i+1)+k2(i+1)+. . . +kn(i+1)=N. (8)

Here, p represents any one of the numbers from 1 to n, and j represents all the numbers excluding p from 1 to n. That is, equation (7) represents (n-1) equations. If the learning calculation is allocated according to k1(i+1) to kn(i+1) obtained by solving these simultaneous equations, although delay occurs when the computing load of each DSP changes in a one-time learning calculation, the load can be evenly balanced in response to the change in the load of the DSPs.

For example, a case is discussed where the entire frequency range is divided into 1024 parts (i.e., N=1024) and the learning calculation is allocated to three DSPs (DSPs 1 to 3) (i.e., n=3). When k1(i)=256, k2(i)=384, k3(i)=384, t1(i)=2 (sec), t2(i)=1 (sec), and t3(i)=1 (sec), the above-described simultaneous equation shows the results of k1(i+1)=146.29≅146, k2(i+1)=438.86≅439, and k3(i+1)=438.86≅439. Consequently, the estimated (i+1)th learning calculation time is about 1.15 (sec). That is, the time is significantly reduced compared with the learning time required in the case where the allocation is predetermined and fixed (2 sec).

Thus, the load balance among the processors can be optimized. Additionally, even when changes in the load of each processor cannot be estimated in advance, this method can be applied.

While the exemplary embodiment has been described with reference to the method using the above-described simultaneous equations, this method is only an example. The allocation of the frequency ranges may be made using another method, such as a linear programming, such that the learning times of the DSPs are equal.

### Third Embodiment (FIG. 2)

Another example of the allocation of separate frame signals according to a third embodiment is described next.

In the third embodiment, a relationship between the load status of each of DSPs and the allocation of the separate frame signal (frequency-domain based separate mixed sound signals) to each DSP is stored in, for example, the memory 112 in advance. Thereafter, in accordance with the stored information, the allocation of the separate frame signals to the DSPs (i.e., allocation scheme of which DSP is responsible for (the learning calculation of) a frame signal in which frequency range) is determined in accordance with the computing loads of the DSPs.

That is, the DSP 1 determines the allocation of the separate frame signals to the plurality of DSPs by selecting the DSPs from among the predetermined candidate DSPs on the basis of the computing loads of the DSPs.

For example, a relationship between all the patterns (a combination) of parallel processing for each DSP and the allocation patterns (candidate allocation patterns) of the separate frame signals may be prestored. Then, the DSP 1 may determine the allocation pattern by selecting the one corresponding to the current processing pattern.

### Fourth Embodiment (FIG. 2)

Another example of the allocation of separate frame signals according to a fourth embodiment is described next.

In the fourth embodiment, the processor usage of each DSP (between 0% and 100%) is categorized into several usage rankings, which serve as the index of the load. The usage ranking is determined by the processor usage of the previous learning calculation. All the combinations of the usage rankings of the DSPs are prestored in association with the allocation pattern (candidate allocation) of the separate frame signals. Then, the DSP 1 may determine the allocation pattern by selecting the one corresponding to the current processing pattern.

By carrying out these processes, when the patterns of load variations in the DSPs can be estimated in advance, the load balancing can be simply and appropriately determined.

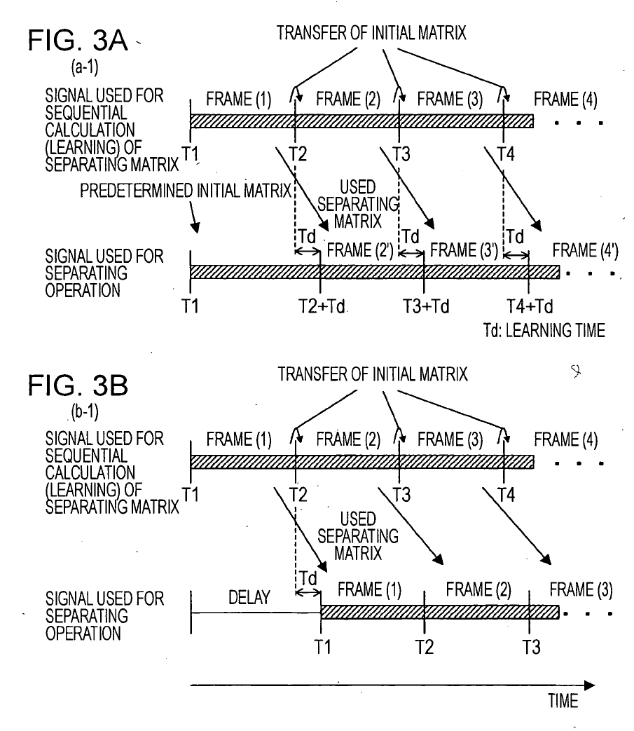

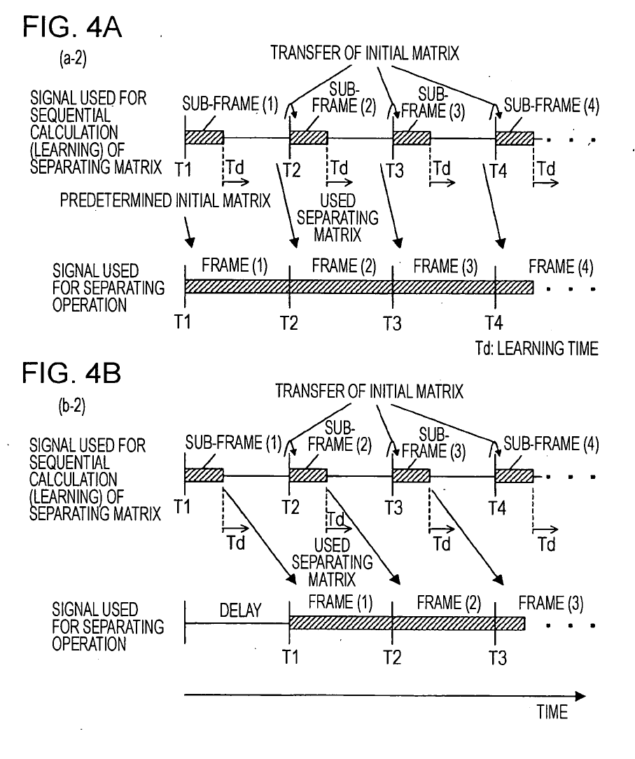

First and second examples of the relationship between a mixed sound signal used for the learning of the separating matrix W(f) and a mixed sound signal subjected to a sound source separation process using the separating matrix W(f) obtained from the learning are described next with reference to time diagrams shown in FIG. 3 (for the first example) and FIG. 4 (for the second example).

FIG. 3 illustrates the time diagram of the first example of the separation of the mixed sound signal used for both the calculation of the separating matrix W(f) (S22 and S35) and the sound source separation process (S16).

In the first example, an input mixed sound signal is divided into frame signals (hereinafter simply referred to as a “frame”) having a predetermined time length (e.g., 3 sec). The learning calculation is carried out for each frame using all the frames.

The case (a-1) in FIG. 3 illustrates a process to carry out a learning calculation of a separating matrix and generate (identify) a separated signal by carrying out a filter process (matrix calculation) on the basis of the separating matrix using different frames. Hereinafter, this process is referred to as a “process (a-1)”. The case (b-1) in FIG. 3 illustrates a similar process using the same frame. Hereinafter, this process is referred to as a “process (b-1)”.

In the process (a-1) shown in FIG. 3, the learning calculation of a separating matrix is carried out using frame(i) corresponding to all the mixed sound signals input during the time period from a time Ti to a time Ti+1 (cycle: Ti+1−Ti). Thereafter, using the obtained separating matrix, the separation process (filtering process) is carried out for frame(i+i)′ corresponding to all the mixed sound signals input during the time period from a time (Ti+1+Td) to a time (Ti+2+Td). Here, Td denotes a time required for the learning of the separating matrix using one frame. That is, using a separating matrix calculated on the basis of a mixed sound signal in one time period, the separation process (identification process) is carried out for a mixed sound signal in the next time period, which is shifted from the current time period by (the time length of a frame+learning time). At that time, to speed the convergence of the learning calculation, it is desirable that the separating matrix calculated (trained) using frame(i) in one time period is used as an initial value (an initial separating matrix) when the separating matrix is (sequentially) calculated using frame(i+1)′ in the next time period.

The process (a-1) corresponds to the process shown in FIG. 2 from which step 15 is eliminated.

In contrast, in the process (b-1) shown in FIG. 3, the learning calculation of a separating matrix is carried out using frame(i) corresponding to all the mixed sound signals input during the time period from a time Ti to a time Ti+1. Simultaneously, all the Frame(i) are stored and, using the separating matrix obtained on the basis of Frame(i), the separation process (filtering process) is carried out for the stored frame(i). That is, a mixed sound signal for (one time period+a learning time Td) is sequentially stored in storage means (a memory) and the separating matrix is calculated (trained) on the basis of all the stored mixed sound signals for one time period. Thereafter, using the calculated separating matrix, the separation process (identification process) is carried out for the mixed sound signal for one time period stored in the storage means. At that time, it is also desirable that the separating matrix calculated (trained) using frame(i) in one time period is used as an initial value (an initial separating matrix) when the separating matrix is (sequentially) calculated using frame(i+1) in the next time period.

The process (b-1) corresponds to the process shown in FIG. 2. The monitoring time at step S15 corresponds to the delay time in the process (b-1) shown in FIG. 3.

As described above, both in the cases of (a-1) and (b-1), the mixed sound signal input in a time series is separated into frames with a predetermined cycle. Every time the frame is input, the separating matrix W(f) is calculated (trained) using the entire input signal. Simultaneously, the separation process, which is a matrix calculation using the separating matrix obtained from the learning calculation, is sequentially carried out so as to generate a separated signal.

If the learning calculation of the separating matrix based on the one entire frame is completed within the time length of the one frame, sound source separation for the entire mixed sound signal can be achieved in real time while the entire mixed sound signal is reflected in the learning calculation.

However, even when the learning calculation is carried out by a plurality of processors in parallel, the learning calculation for providing a sufficient sound source separation performance is not always completed within a time period for one frame (Ti to Ti+1).

Accordingly, in a first example shown in FIG. 4, the input mixed sound signal is separated into frame signals (frames) having a predetermined time length (e.g., 3 sec). The learning calculation is carried out for each frame using a part of the frame signal from the head thereof. That is, the number of samples of the mixed sound signal used for the sequential calculation of the separating matrix is reduced (thinned out) from that of the normal case.

Thus, the computing amount of the learning calculation can be reduced. Consequently, the learning of the separating matrix can be completed in a shorter cycle.

Like FIG. 3, FIG. 4 illustrates the timing diagram of the second example of the separation of the mixed sound signal used for both the calculation of the separating matrix W(f) (S22 and S35) and the sound source separation process (S16).

The case (a-2) in FIG. 4 illustrates a process to carry out a learning calculation of a separating matrix and generate (identify) a separated signal by carrying out a filtering process (matrix calculation) using different frames. Hereinafter, this process is referred to as a “process (a-2)”. The case (b-2) in FIG. 4 illustrates a similar process using the same frame. Hereinafter, this process is referred to as a “process (b-2)”.

In the process (a-2) shown in FIG. 4, the learning calculation of a separating matrix is carried out using the front part of frame(i) (e.g., a part from the beginning of the frame(i) for a predetermined time length) corresponding to the mixed sound signal input during the time period from a time Ti to a time Ti+1 (cycle: Ti+1−Ti). Hereinafter, the part of the signal is referred to as a “sub-frame(i)”. Thereafter, using the obtained separating matrix, the separation process (filter process) is carried out for frame(i+1) corresponding to the entire mixed sound signal input during the time period from a time Ti+1 to a time Ti+2. That is, using a separating matrix calculated on the basis of the front part of a mixed sound signal in one time period, the separation process (identification process) is carried out for a mixed sound signal in the next time period. At that time, to speed the convergence of the learning calculation, it is desirable that the separating matrix calculated (trained) using the front part of frame(i) in one time period is used as an initial value (an initial separating matrix) when the separating matrix is (sequentially) calculated using frame(i+1) in the next time period.

The process (a-2) corresponds to the process shown in FIG. 2 from which step S15 is eliminated.

In contrast, in the process (b-2) shown in FIG. 4, the learning calculation of a separating matrix is carried out using Sub-frame(i), which is a front part (e.g., a part from the beginning of a frame for a predetermined time length) of frame(i) corresponding to the entire mixed sound signal input during the time period from a time Ti to a time Ti+1. Simultaneously, the entire frame(i) is stored and, using the separating matrix obtained on the basis of the Sub-frame(i), the separation process (filter process) is carried out for the stored frame(i). At that time, it is also desirable that the separating matrix calculated (trained) using the sub-frame(i) of the frame(i) in one time period is used as an initial value (an initial separating matrix) when the separating matrix is calculated using Sub-frame(i+1) of frame(i+1) in the next time period.

As noted above, limiting the mixed sound signal used for the learning calculation for finding a separating matrix to the front time part of each frame signal allows the learning calculation to be completed in a shorter cycle.

What is claimed is:

1. A sound source separation apparatus comprising:
a plurality of sound input means for receiving a plurality of mixed sound signals, sound source signals from a plurality of sound sources being overlapped in each of the mixed sound signals;
frequency-domain transforming means for performing a discrete Fourier transform on each of the mixed sound signals for a predetermined time length in a time domain and sequentially transforming the mixed sound signals to frequency-domain-based mixed sound signals representing mixed sound signals in a frequency domain;
separating matrix calculating means for allocating learning calculations of a separating matrix using a blind source separation based on independent component analysis to a plurality of processors for each of separate frequency-domain mixed sound signals generated by separating the frequency-domain-based mixed sound signal into a plurality of pieces with respect to frequency range and causing the plurality of processors to carry out the learning calculations in parallel so as to sequentially output the separating matrix;
sound source separating means for sequentially generating a separated signal corresponding to the sound source signal from the frequency-domain-based mixed sound signal by performing a matrix calculation using the separating matrix; and
time domain transforming means for performing an inverse discrete Fourier transform on one or more separated signals.

2. The sound source separation apparatus according to claim 1, further comprising:
signal allocation setting means for determining allocation of the separate frequency-domain mixed sound signals to the processors on the basis of a processing load of each processor.

3. The sound source separation apparatus according to claim 2, wherein the signal allocation setting means determines the allocation of the separate frequency-domain mixed sound signals to the processors by selecting a candidate allocation from among a plurality of predetermined candidate allocations on the basis of a processing load of each processor.

4. The sound source separation apparatus according to claim 2, wherein the signal allocation setting means determines the allocation of the separate frequency-domain mixed sound signals to the processors by means of a computation based on actual times spent for the learning calculations of the separating matrix by the plurality of processors.

5. A sound source separation method, comprising the steps of:
receiving a plurality of mixed sound signals, sound source signals from a plurality of sound sources being overlapped in each of the mixed sound signals;
performing a discrete Fourier transform on each of the mixed sound signals for a predetermined time length in a time domain and sequentially transforming the mixed sound signals to frequency-domain-based mixed sound signals representing mixed sound signals in a frequency domain;
allocating learning calculations of a separating matrix using a blind source separation based on independent component analysis to a plurality of processors for each of separate frequency-domain mixed sound signals generated by separating the frequency-domain-based mixed sound signal into a plurality of pieces with respect to frequency range and causing the plurality of processors to carry out the learning calculations in parallel so as to sequentially output the separating matrix;
sequentially generating a separated signal corresponding to the sound source signal from the frequency-domain-based mixed sound signal by performing a matrix calculation using the separating matrix; and
performing an inverse discrete Fourier transform on one or more separated signals.

6. The sound source separation method according to claim 5, further comprising the step of:
determining allocation of the separate frequency-domain mixed sound signals to the processors on the basis of a processing load of each processor.

7. The sound source separation method according to claim 6, wherein the step of determining the allocation of the separate frequency-domain mixed sound signals to the processors is performed by selecting a candidate allocation from among a plurality of predetermined candidate allocations on the basis of a processing load of each processor.

8. The sound source separation method according to claim 6, the step of determining the allocation of the separate frequency-domain mixed sound signals to the processors is performed by means of a computation based on actual times spent for the learning calculations of the separating matrix by the plurality of processors.
